(19) United States
(12) Patent Application Publication
(10) Pub. No.: US 2014/0057487 A1
(43) Pub. Date: Feb. 27, 2014

(54) Repositionable Cord Mounts for Data Communication and Power Supply

(71) Applicant: William May, Locust Valley, NY (US)

(72) Inventor: William May, Locust Valley, NY (US)

(21) Appl. No.: 13/772,423

(22) Filed: Feb. 21, 2013

Related U.S. Application Data
(60) Provisional application No. 61/601,314, filed on Feb. 21, 2012.

(51) Int. Cl. H01R 13/60

(52) U.S. Cl. CPC H01R 13/60
USPC 439/530

(57) ABSTRACT

Repositionable cord mounts which have sufficient yield strength to support an electronic device in a desired orientation so that, for example, the screen of a smartphone can be elevated and/or positioned at any desired elevated position and inclined angle while being supported entirely by a cord mount. The cord mounts comprise plugs having plug bodies, typically formed of a polymeric material, from which electrical connectors extend. The surface of the plug body from which the conductive portions extend is referred to herein as the “protrusion surface”. All support for an electronic device connected to a plug is provided by one or more male portions and the protrusion surface.

### RELATED APPLICATION DATA

This application claims the benefit of Provisional Patent Application Ser. No. 61/601,314 filed on Feb. 21, 2012, which is hereby incorporated by reference.

The various embodiments of the present invention are directed to repositionable cord mounts comprising male terminal plugs at opposite ends for connecting electronic accessories, e.g. a personal computer to a smartphone. The cord mounts are configured to plug into an electrical receptacle of the device to be supported and have sufficient yield strength and stability to support one of the devices in an elevated, desired position while providing electrical communication between the two electronic devices for data communication and/or power supply.

### BACKGROUND OF THE INVENTION

With the proliferation of electronic devices including smartphones, PDAs, etc. it is known to connect two devices, for example a smartphone with a laptop computer, in order to transfer data and to charge one of the devices. Most common cables are typically highly flexible so that they can be readily folded up for storage while requiring minimum storage space. Additionally, users of modern electronic devices may often have two or more electronic devices. At various times, a user will desire to use one, two, or perhaps more devices simultaneously.

### SUMMARY

The present invention provides clean, simple, efficient and aesthetically pleasing cord mounts wherein the only connection between the cord mount and the device is provided at the electrical connection, i.e. between the plug of the cord and the sockets (receptacle of the electronic device) area. The embodiments of the present invention do not comprise any other support structure which engages the electronic devices. Embodiments of the present invention are therefore different from prior support devices which utilize additional support structure for supporting a device.

Various embodiments of the present invention are directed to repositionable cord mounts (referred to herein as “Cords”) which have sufficient yield strength to support an electronic device in a desired orientation so that, for example, the screen of a smartphone can be elevated and/or positioned at any desired elevated position and inclined angle while being supported entirely by a Cord.

The Cords can support an electronic device weighing up to 1.5 pounds, such as a smartphone, PDA, small tablet, etc. while connecting that electronic device to a second electronic device such as a computer monitor, laptop or 5V car charger. Preferred embodiments are capable of both data communication (transmission/reception) and power supply. When plugged into a monitor, laptop, or car charger, the yield strength and length of the Cord preferably allows optimal placement of the device, e.g. at eye level of the user and/or close to the monitor, laptop screen, or front window of a vehicle. The device is more easily viewed when positioned close to the primary focus of the user or close to the line of sight of the activity, e.g. whether when using with a computer or while driving a car, respectively, because less rotational movement of the head allows easier reference to the device for information, e.g. driving directions.

In some embodiments the Cords comprise plugs having plug bodies, typically formed of a polymeric material, from which conductive portions of the electrical connectors extend. The surface of the plug body from which the conductive portions extend is referred to herein as the “protrusion surface”. The plug bodies of the present invention do not extend beyond the protrusion surface in the direction of the conductive portion. Therefore, all support for an electronic device connected to a Cord of these embodiments is provided by the conductive portion and the protrusion surface. There are no additional supports extending from the plug body or from the cord to support the device. The only contact between the device and the Cord is provided by the conductive portion and the protrusion surface.

Some embodiments of the present invention are provided with at least one oversized plug which is insertable into a standard receptacle having standardized dimensions and which is designed to receive a plug of standardized dimensions. The plugs of these embodiments of the present invention have at least one dimension, e.g. a height or width, which is larger than the corresponding portion of plugs of standardized dimensions.

Alternative embodiments have plugs provided with additional standard shaped male portions extending from the protrusion surface in order to provide a better connection between the Cord and an electronic device. The male portions which extend past the protrusion surface and are shaped similar to or identical to an electrical connection intended to transmit data and power, and are referred to herein as a “male portion”. The additional male portions, which may be dummy, i.e. non-conductive plugs which do not transmit power or data, and which are insertable into one or more standard receptacles on an electronic device, are positioned on the plug body such that all male portions extend from the protrusion surface and can be inserted into the electronic Device at the same time. Therefore, all support for an electronic device connected to a Cord of these embodiments is provided by the male portion(s) which connect internally to a device's female receptacle(s) and the protrusion surface. There are no supports extending from the plug body or from the cord to support exterior surfaces of the electronic device. In these embodiments the only contact between the electronic device and the Cord is provided between the male portion surfaces and the internal female receptacle surfaces and between the protrusion surface and the corresponding portion of the electronic device.

Additionally, a Cord can serve as a stand by itself for an electronic device, e.g. when unattached to a second device or when connected to a common, non-supporting female USB-A Cord.

Various embodiments of repositionable cord mounts are described below and shown in the attached figures.

### BRIEF DESCRIPTION OF THE DRAWINGS

FIG. 1 illustrates an embodiment of the invention connected to a smartphone and a computer monitor.

FIG. 2 illustrates the embodiment of FIG. 1 connected to a smartphone and a laptop computer.

FIG. 3 illustrates the embodiment of FIG. 1 with a longer cord connected to a smartphone and a 5 volt USB car charger positioned in a car charger receptacle.

FIGS. 4 and 5 are perspective views of a second embodiment of the present invention.

FIG. 6 is a perspective view of a third embodiment of the present invention.

FIG. 7 is a partial view, with sections removed, of the second embodiment.

FIG. 8 is a partial view, with sections removed, of a fourth embodiment.

FIG. 9 illustrates a fifth embodiment of the present invention.

FIG. 10 is a partial view of the embodiment shown in FIG. 9 with sections removed.

FIG. 11 illustrates a sixth embodiment of the present invention.

FIG. 12 is a partial view of the embodiment shown in FIG. 11 with sections removed.

FIG. 13 illustrates a seventh embodiment of the present invention.

FIG. 14 is a partial view of the embodiment shown in FIG. 13 with sections removed.

FIGS. 15, 16 and 17 are perspective, top and end views, respectively, of a USB-A male plug of the present invention.

FIGS. 18, 19, and 20 are perspective, top and end views, respectively, of an enlarged USB-A male plug of the present invention.

FIGS. 21, 22 and 23 are top, front and right views, respectively, of a 30-pin male plug of the present invention.

FIGS. 24, 25 and 26 are top, right and front views, respectively, of a micro-B male plug of the present invention.

FIGS. 27 and 28 illustrate a embodiment of the present invention acting as a stand for a device as a stand alone and as connected to a non-supporting cable, respectively.

FIGS. 29 and 30 illustrate the embodiment shown in FIG. 4 acting as a stand for a device as well as a USB connection for supplying power and a data link to the device.

FIGS. 31 and 32 illustrate an alternative embodiment with an additional male portion.

### DETAILED DESCRIPTION

Each of the cord mounts of the present invention are configured to plug into a standard electrical receptacle, sometimes referred to as a socket, of an electronic device. The cord mounts have sufficient yield strength and stability to support an electronic device in a desired position while providing electrical communication between two electronic devices, preferably for both data communication and power supply. The only support for the one or more electronic devices connected to a Cord is provided by the plug-receptacle connection(s). As used herein, the term “plug” includes the protrusion(s), typically comprising a conductive metal, as well as the body portion which is typically gripped by a user when inserting or removing the conductive portion into/from an electronic device. The support provided by the Cords of the present invention is provided by the conductive protrusion and the distal surface of the plug body immediately adjacent the protruding conductive portion, which surface is referred to herein as the “protrusion surface”. Other than the protrusion(s) from the protrusion surface and the protrusion surface itself, there is no other support structure for the electronic device provided by the Cord. Other than the protrusion portions, the present invention does not provide lateral support, other than to the extent that the protrusion surface minimizes rocking of the electronic device relative to the Cord. Using no other support structure to support the device in a specific location and orientation is a substantial benefit to usability, simplicity, and adaptability to different electronic devices and protective cases a user may have around the electronic device. In a single action, i.e. plugging a Cord into an electronic device, the device is connected and supported by the Cord. The Cords of the present invention do not require a secondary motion in order to attach an electronic device to a Cord nor to release one, as do some previously known support devices which have secondary arms or support plates. Since the Cords of the present invention do not have secondary arms or supports to engage an external surface of the electronic device, there will be very few occasions when a Cord of the present invention does not work when the electronic device is in a protective case or when an electronic device has accessories attached at positions other than at the receptacle to which the Cord is connected.

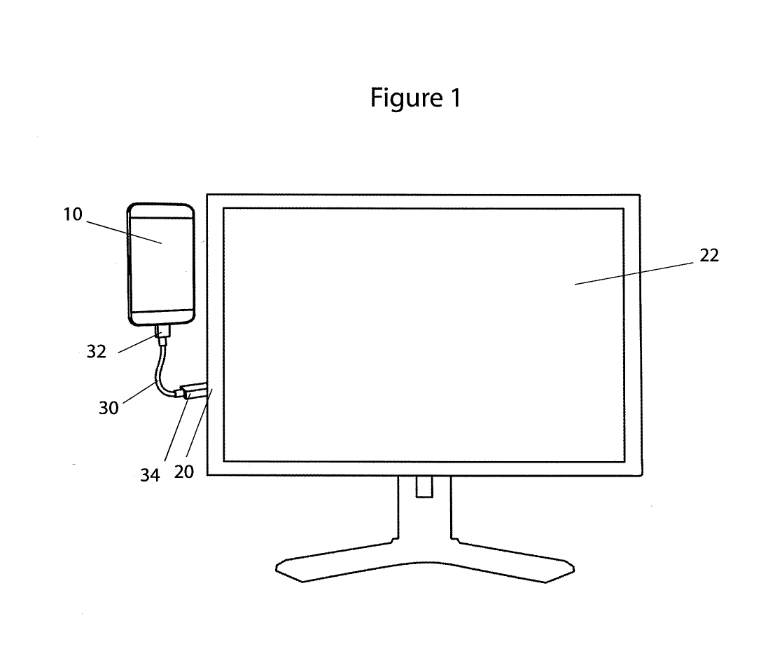

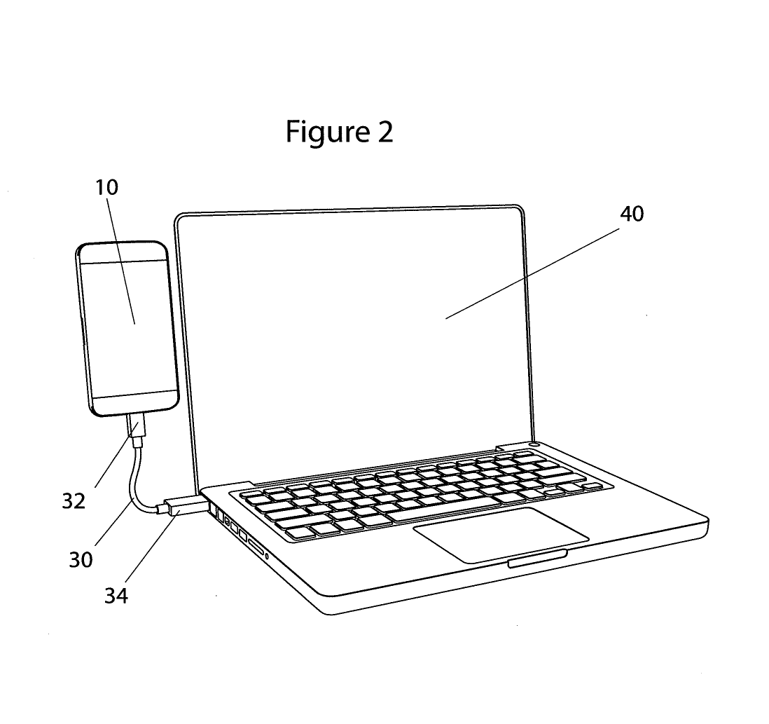

One embodiment of the present invention comprises a repositionable cord mount comprising opposite terminal ends. FIGS. 1-3 illustrate some different uses of the present invention. FIG. 1 illustrates smartphone 10 connected to a computer monitor 20 with a repositionable cord mount 30 of the present invention. Cord mount 30 comprises a first plug 32 for connecting with smartphone 10 and a second plug 34 for connecting with the computer monitor 20. In this manner, a user can view images on monitor screen 22 as well as on smartphone 10. FIG. 2 illustrates a smartphone 10 connected to a laptop computer 40 with a repositionable cord mount 30 of the present invention. FIG. 3 illustrates smartphone 10 supported by repositionable cord mount 30 with plug 34 plugged into a standard 5 volt USB car charger 60 which is, in turn, plugged into a standard car charging receptacle. FIG. 3 shows the same type Cord as in FIGS. 1 and 2, but with a longer supporting cord.

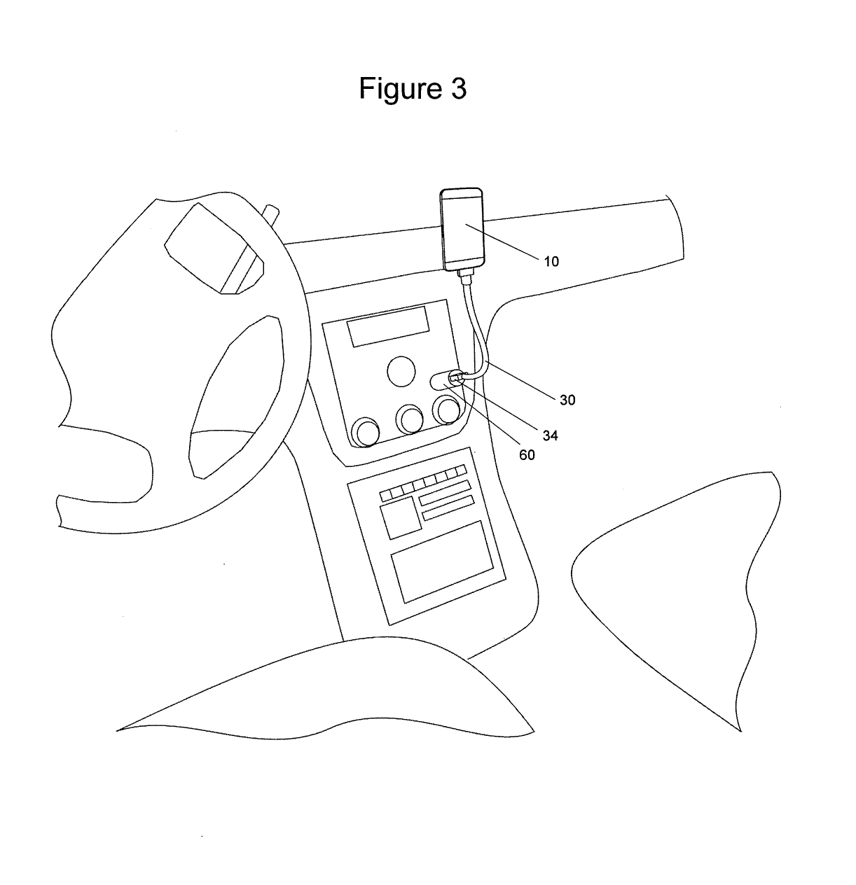

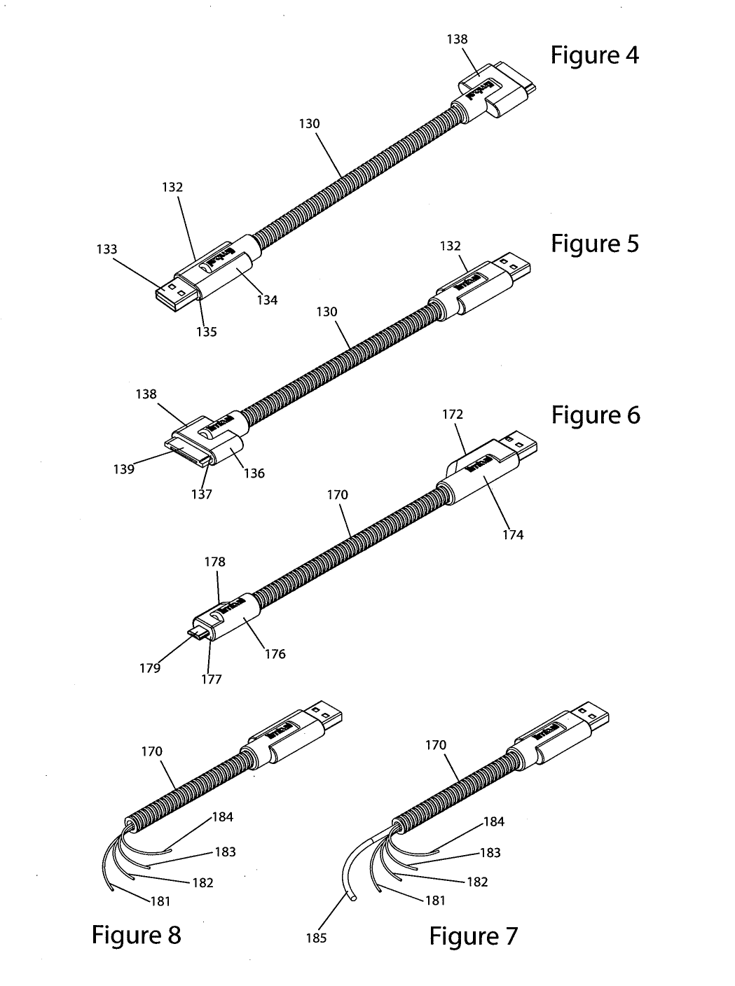

Exemplary embodiments of repositionable cord mounts of the present invention are illustrated in FIGS. 4-14.

FIGS. 4 and 5 illustrate one preferred embodiment of the present invention comprising a cord body 130 in the form of a coiled metal gooseneck conduit body, a first plug 132 comprising a standard USB-A plug and a second plug 138 comprising a standard 30 pin plug. This embodiment of the present invention comprises internal wires for both power and data communication which are not shown. With reference to FIG. 4, USB-A plug 132 comprises a polymeric body 134 having a protrusion surface 135 and a conductive protrusion 133 extending beyond protrusion surface 135. The 30 pin plug 138, shown better in FIG. 5, comprises a polymeric body 136 having a protrusion surface 137 and a conductive portion 139. The coiled metal gooseneck body has sufficient yield strength to support an electronic device of up to about 1.5 pounds in any desired orientation indefinitely and regardless of which plug the electronic device is attached.

FIG. 6 illustrates a further embodiment of the present invention comprising a USB-A plug 172 having a plug body 174 shaped slightly differently from the plug body 132 of the previous embodiment, a goose neck body 170 and a micro USB-B plug 178 comprising a polymeric body 176, a protrusion surface 177 and a conductive protruding portion 179. As with the embodiment of FIGS. 4 and 5, the embodiment of FIG. 6 has sufficient yield strength to support an electronic device in any orientation. In other words, the cord body which connects the two terminal plugs has sufficient yield strength to support such an electronic device.

The yield strength can be provided entirely by the coiled metal gooseneck conduit or the yield strength of the coiled metal gooseneck can be supplemented by an insert, such as a bendable metal wire. FIG. 7 is a partial view of the embodiment shown in FIG. 6 showing internal data wires 181,182 as well as internal power cables 183,184. Additionally, a bendable metal wire 185 is positioned within the coiled metal gooseneck conduit body and is connected to both plugs of cord mount 170 in order to increase the yield strength of the cord mount. FIG. 8 illustrates an alternative embodiment which is similar to the embodiment illustrated in FIG. 7 but does not have the metal wire 185.

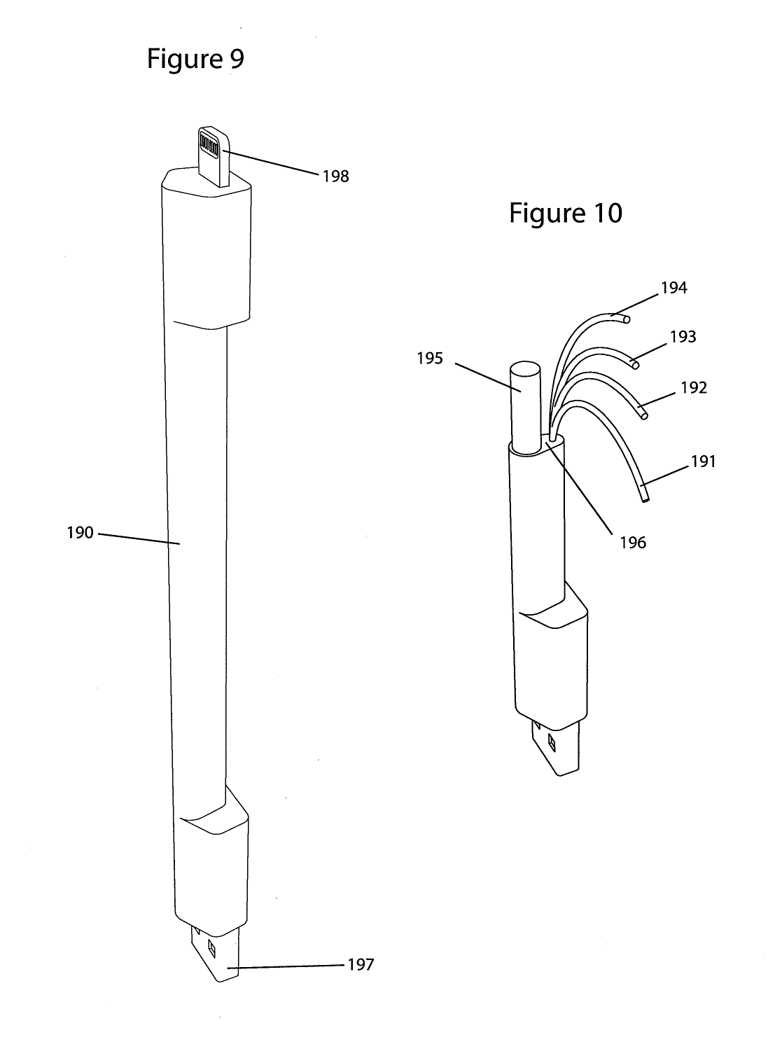

With reference to FIGS. 9 and 10, which illustrate a fifth embodiment of the present invention wherein a repositionable cord mount 190 comprises data transfer cables 191,192, power cables 193,194, a flexible support 195 in the form of a metal wire encased within a soft rubber sheath or overmolding 196, a male USB-A connector 197 and an Apple® Lightning connector 198. As illustrated in FIG. 10 which illustrates a portion of Cord 190 with sections removed, data cables 191, 192 are positioned next to flexible metal wire 195 and both are encased within the soft rubber sheath 196. The soft rubber sheath maintains the metal wire 195 in position relative to the two male plugs 197 and 198. The metal wire 195 is dimensioned to have sufficient yield strength and is sufficiently flexible to allow cord mount 190 to be bent while supporting an electronic device having a weight of up to 1.5 pounds in any desired position. Thus, the flexible support 195 is strong enough so that the device is supported in the desired position without drooping over time but is flexible enough so that a user can bend the Cord 190 in order to re-position the device into a desired position relative to the other electronic device. FIG. 9 illustrates this embodiment of the present invention in a generally linear configuration.

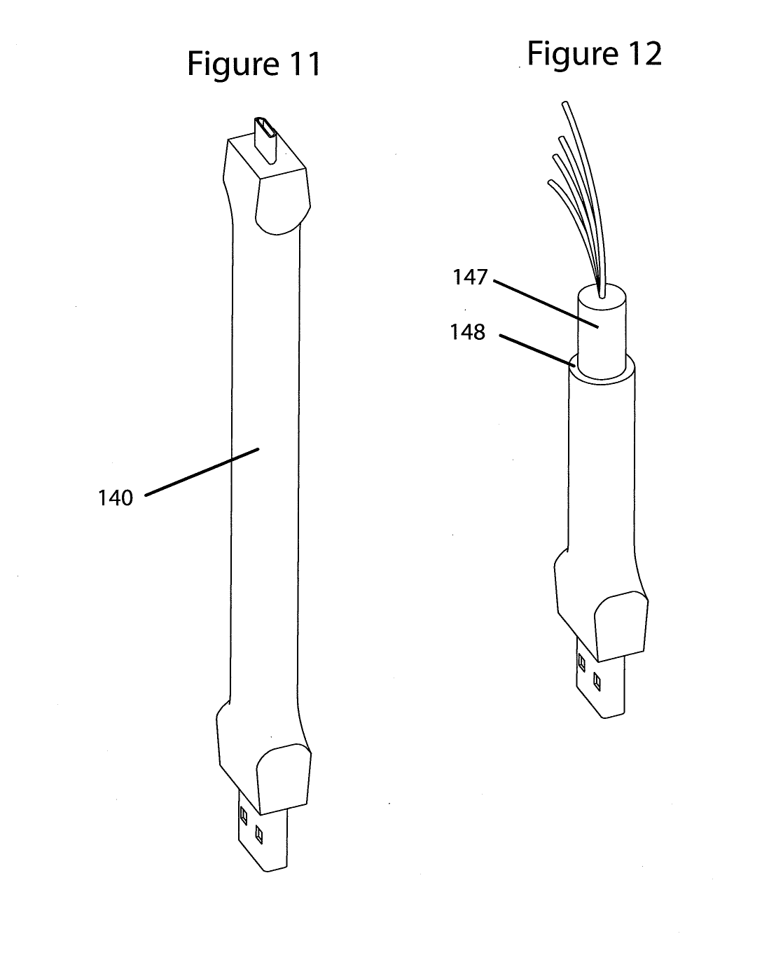

According to an alternative embodiment of the present invention shown in FIGS. 11 and 12, the Cord requires some heating in order to bend the Cord into the desired configuration. According to this embodiment of the present invention, a Cord 140 comprises a layer of polycaprolactone (PCL) 147 molded around the data/communication cables and is disposed inside a soft sheath 148. The polycaprolactone 147 is sufficiently rigid and stiff at room temperature, but gets soft and bendable at about 150 degrees Fahrenheit. Users place the Cord in an oven at a low setting or utilize some other heat source which supplies sufficient heat to bring it to the appropriate temperature. After about 10 minutes in an oven set at 140-160° F., the user is able to bend the Cord into position and then waits a few minutes for it to cool and harden. After hardening takes place, the user then connects the Device and begins to use the Cord in the rigid state. An alternative to the embodiment illustrated in FIGS. 11 and 12 replaces the polycaprolactone with moldable paraffin wax, but is otherwise constructed in the same manner.

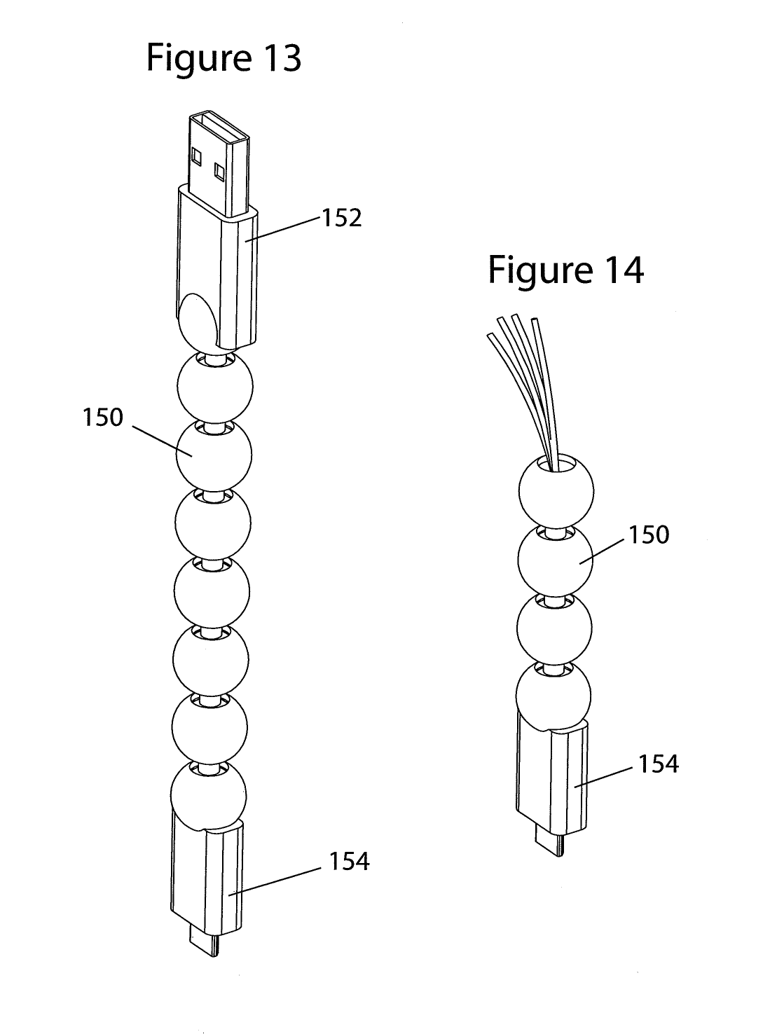

According to another embodiment of the present invention illustrated in FIGS. 13 and 14, a plurality of hollow ball pivot-links 150 (such as those described in U.S. Pat. No. 4,397,145 which is hereby incorporated by reference) form a hollow chain body. The hollow insides of the ball links 150 house the necessary data and power cable(s) for USB functionality between male USB-A plug 152 and Micro USB-B plug 154. The friction between the surfaces of the ball pivot-links provides sufficient yield strength to support the weight of an electronic device up to about 1.5 pounds without drooping.

Thus, it will be appreciated that the terminal ends of the cord mounts are connected with suitable electrical conductors, e.g. USB cable(s). The desired yield strength can be provided by the particular conduit used, as in the case of the coiled metal gooseneck, or the conduit can be combined with a flexible substrate integrated into an insulating sheath, e.g. plastic. The Cord can be of any desired length, but it is preferably about 5-12 inches long, most preferably about 6-8 inches long. The yield strength and stability of the flexible cord body allows the Cord to retain any desired position even when under stress from the weight of the device, e.g. up to about 1.5 pounds. This allows a user to attach a smartphone, iPhone, media player or other similar electronic devices (generally referred to herein as “Device”) to a computer monitor, laptop, car charger or any female USB-A port 34.

According to some presently preferred embodiments, one end of the repositionable cord mount comprises an enlarged male plug, e.g. an enlarged male USB-A plug while the opposite end comprises a standard plug, e.g. a male Micro USB-B connector, a standard mini USB connector, a standard Apple 30 pin connector, or standard audio jacks (either 2.5 mm or 3.5 mm). Thus, according to these embodiments of the present invention, at least one portion of at least one of the respective connectors is larger in height and/or width than a standard plug in order to provide a more solid, tighter connection to the electronic device(s). As noted above, the connection between the male plug of the Cord and the device is limited to the connection between the plug and the receptacle of the electronic device. The Cord does not engage the device other than with the protrusion surface and conductive portion.

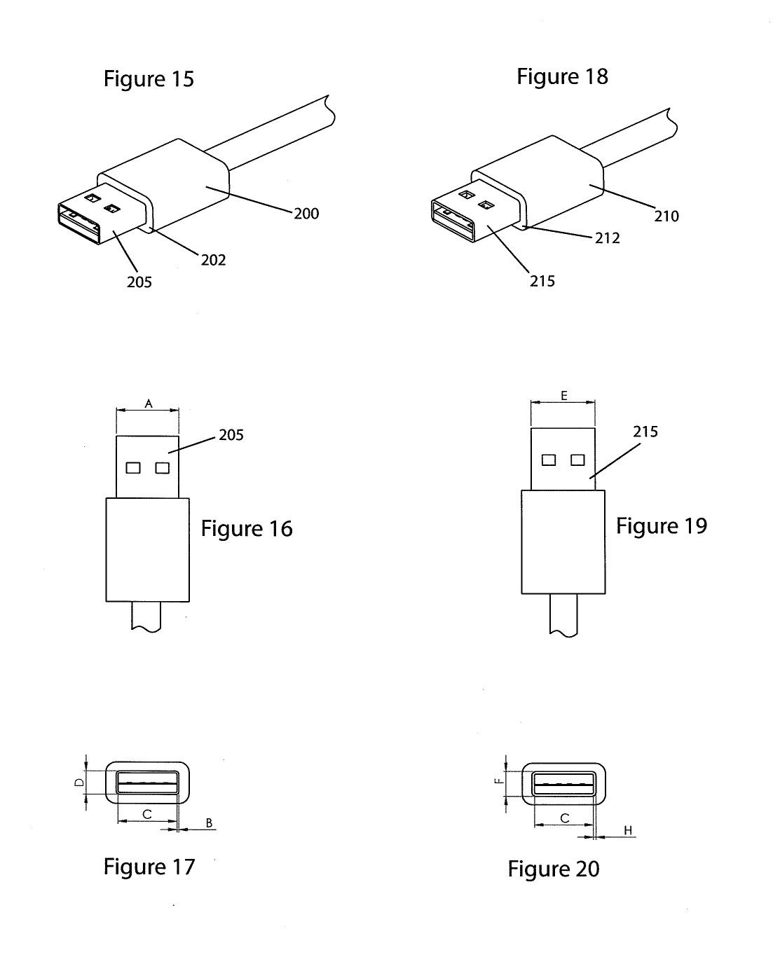

FIGS. 15-17 illustrate a standard male USB-A plug while corresponding FIGS. 18-20 illustrate an enlarged USB-A plug. FIG. 15 is a perspective view of a plug comprising a plug body 200, a protrusion surface 202 and a protruding conductive portion 205. As shown in FIG. 16, conductive portion 205 has an external width A and, with reference to FIG. 17, an internal width C, an external height D and wall thickness B. The enlarged USB-A plug shown in FIG. 18-20 has a polymeric body 210 with a protrusion surface 212 and a conductive portion 215. As shown in FIG. 19, conductive protrusion 215 has an external width E and, with reference to FIG. 20, an internal width C, an external height F and a wall thickness H. The vertical height and width of the standard USB-A plug shown in FIGS. 15-17, as specified by the Universal Serial Bus—International Forum, is 4.5 mm and 12 mm, respectively. Thus, dimension D is 4.5 mm and A is 12 mm. The height and width of embodiments of the enlarged USB-A plugs of the present invention are 4.6-4.9 mm and 12.1-12.4 mm, respectively. Therefore, dimension F shown in FIG. 20 is 4.6-4.9 mm while dimension E is 12.1-12.4 mm.

Additionally, the wall thickness of the conductive portion of plug 205 is increased. The standard wall thickness indicated as dimension B is 0.315 mm ∀ 0.03 mm. In the enlarged plug, the wall thickness indicated by dimension H is at least 0.5 mm.

As indicated by FIGS. 17 and 20, the internal width of the conductive portion of the two plugs, namely dimension C in both plugs, is the same.

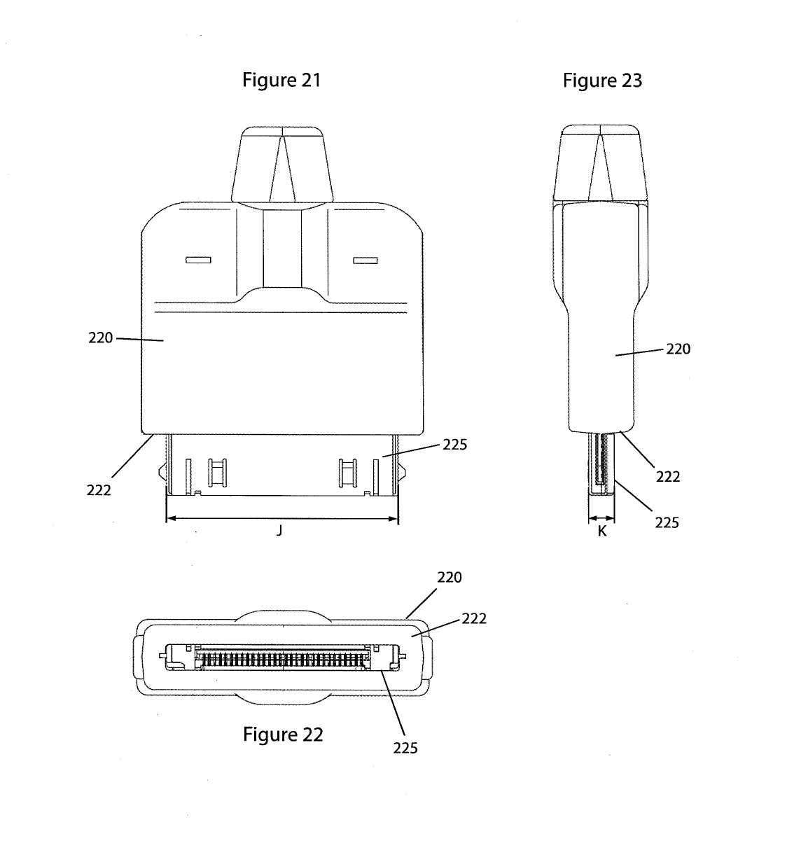

FIGS. 21-23 are a top view, front view, and a right side view, with sections removed, respectively, of a 30 pin plug having a body 220, a protrusion surface 222, and a conductive portion 225 extending from protrusion surface 222. The conductive portion 225 has a width J and height K. The vertical height and width of a standard 30 pin plug are 2.35 mm and 14.5 mm, respectively. The height and width of enlarged 30 pin plugs of the present invention are at least 2.45 mm and 14.65 mm, respectively. Thus, according to embodiments of the present invention with enlarged standard 30 pin plugs, dimension K is at least 2.45 mm and/or dimension J is at least 14.65 mm. According to the present invention, only one dimension may be increased in an enlarged plug. Alternatively, it is also within the scope of the present invention to provide an enlarged plug with more than one dimension greater than the standard dimensions.

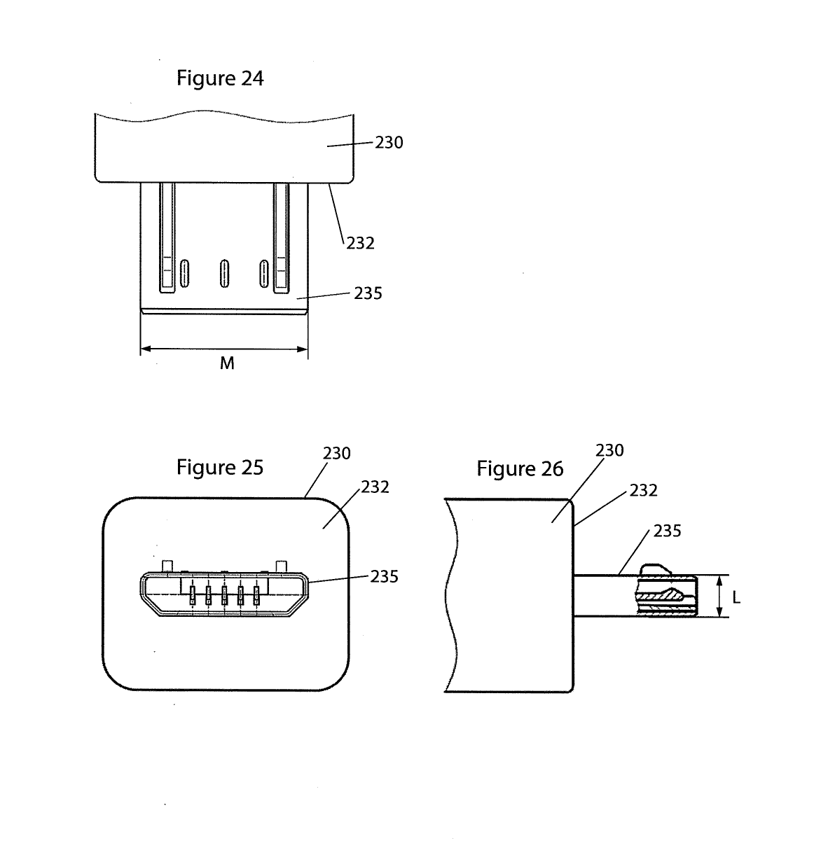

FIGS. 24-26 show a top view, front view and right side view with portions removed, respectively, of a micro-B male plug wherein the conductive portion of the plug has an external width M and a height L. The illustrated micro-B plug comprises a body 230, a protrusion surface 232 and a conductive portion 235 extending from protrusion surface 232. The vertical height and width of a standard Micro-B plug, as specified by the Universal Serial Bus—International Forum, are 1.8 mm and 6.85 mm, respectively. The height and width of enlarged micro-B plugs of preferred embodiments of the present invention are at least 1.9 mm and at least 7.02 mm, respectively. Thus, dimension L of enlarged micro-B plugs of the present invention is at least 1.9 mm and/or dimension M is at least 7.02 mm.

As noted above, one preferred embodiment of the present invention has an enlarged male USB-A plug and a standard size male plug at the other end of the cord. It is also within the scope of the present invention to provide a cord mount with enlarged plugs at both ends or to provide a single enlarged plug which is other than a male USB-A plug.

The dimensions of the preferred enlarged plugs of the present invention accomplish two things. First, they minimize “wiggle”, i.e. movement of the cord to move from side to side relative to the electronic device while mounted. Wiggle may lead a user to think the cord has a weak connection and destroys confidence in the safety of the connection or the integrity of the Cord. Secondly, the increased dimension(s) create more pressure and thus more friction between the mated metal surfaces which increases the amount of force required to remove the cord from the female receptacles. This increases the safety of the product and minimizes the risk of a supported electronic Device from falling and breaking.

The internal dimensions and location of the electrical connectors of the enlarged plugs, including the metal contacts of the data and power connections, are not altered relative to standard plugs as this might damage the female receptacle over time and detrimentally loosen the port for other devices or cord uses.

While certain types of plugs are illustrated herein, the present invention is useful with other plugs including other types of USB plugs including Standard Type-B, 2.0 Mini Type-B, 2.0 Micro Type-B, 3.0 Micro Type-B, speaker and/or earphone plugs, and other types of plugs for providing power and/or data communication with electronic devices.

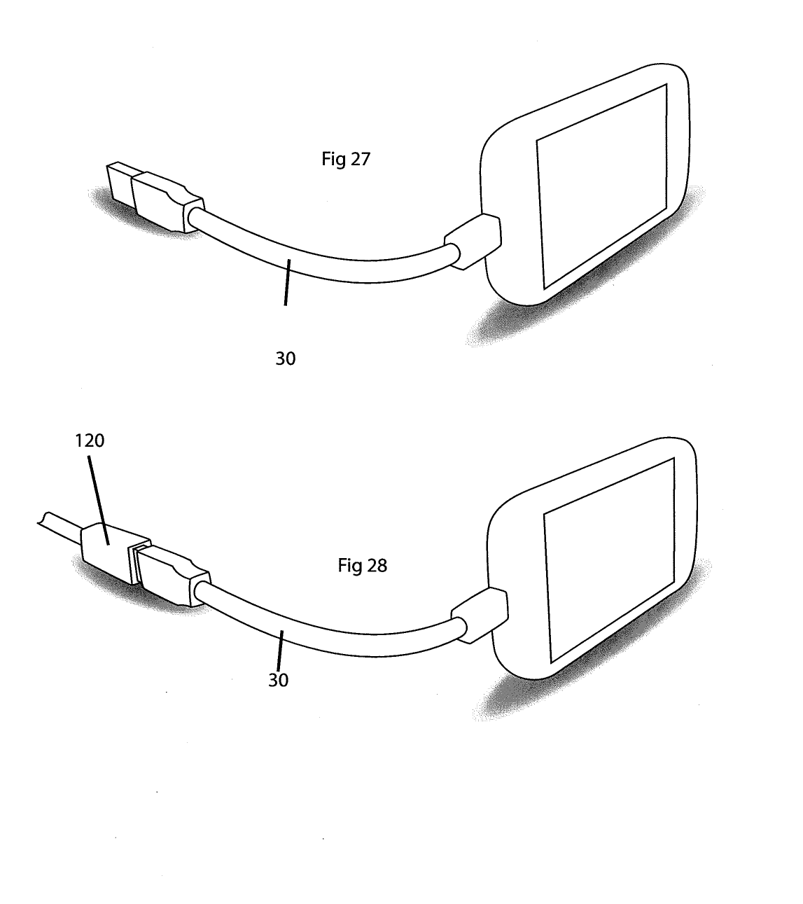

FIG. 27 illustrates an electronic device 110 and a repositionable cord mount 130 of the present invention. In this configuration, the cord mount 30 is not connecting the electronic device 110 to another electronic device. The repositionable cord mount 30 is simply acting as a stand to support the electronic device 110 in an inclined position.

The configuration of FIG. 28 is similar to that shown in FIG. 27, however the end of the repositionable cord mount 30 opposite the electronic device 110 is connected to a standard, non-supporting, USB cable 120.

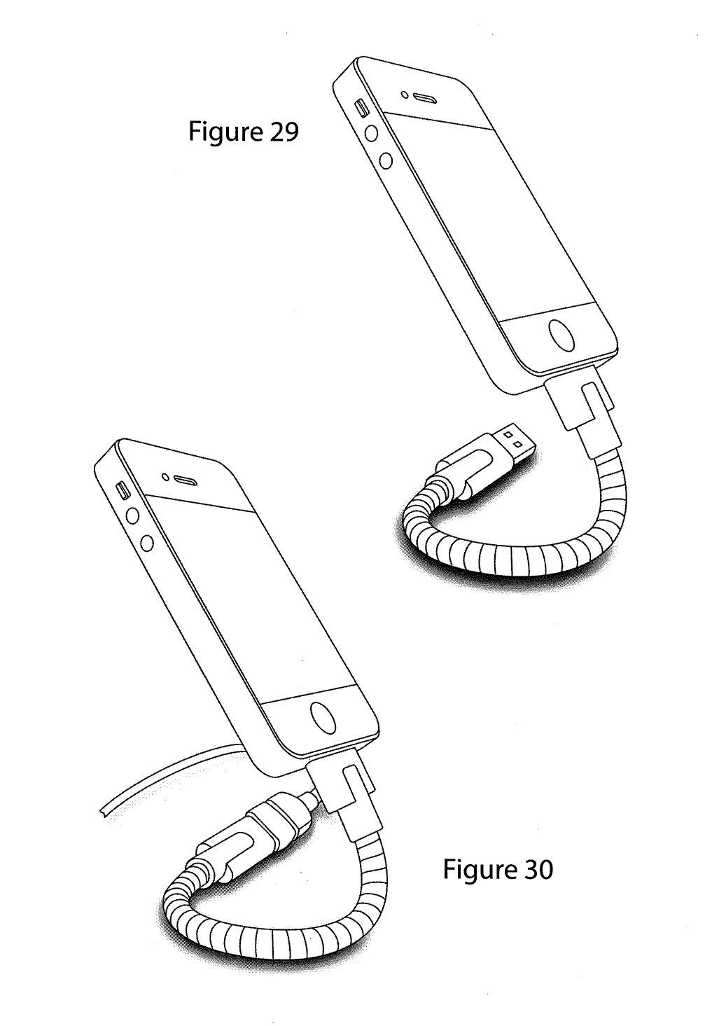

FIGS. 29 and 30 illustrate the embodiment shown in FIG. 4 connected to a phone which is supported in an elevated and inclined orientation for easy viewing by a user. As indicated, if the user wishes to use the phone in portrait mode on a surface, such as a desktop, coiling the Cord can create a base on which the phone is supported and elevated. A coiled base arrangement can be used without or with a standard non-supporting USB cord to provide power and/or data as shown in FIGS. 29 and 30, respectively.

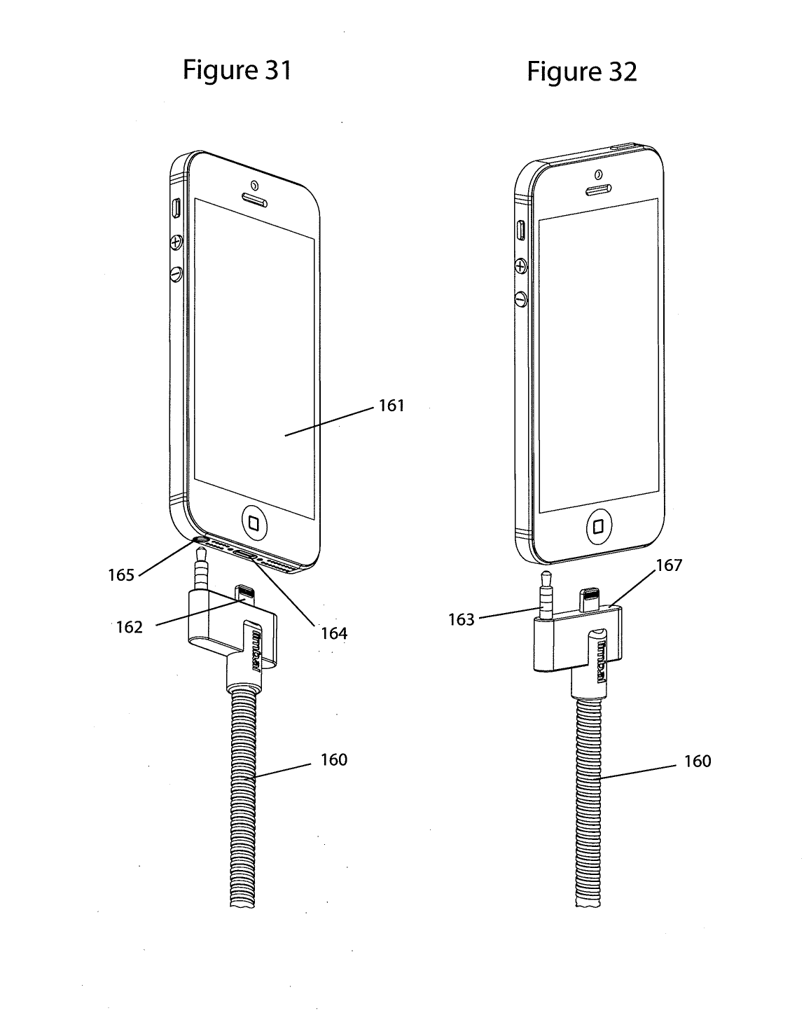

According to an alternative embodiment of the present invention shown in FIGS. 31 and 32, an Apple Lightning® connector 162 extends from the protrusion surface 167 of a coiled metal gooseneck Cord 160. The male portion of the Apple Lightning® connector is inserted into a female Apple Lightning® receptacle 164 on the bottom surface of an electronic device 161 in order to transmit data and/or power as well as to connect and support the device with said Cord. In order to provide additional support without structures connecting to the exterior of the device, an additional male portion 163 in the shape of a 3.5 mm audio connector extends from the same protrusion surface 167 to connect internally to a female 3.5 mm audio receptacle 165 of the electronic device. The 3.5 mm audio “connector” is preferably formed entirely of a nonconductive polymeric material in order to prevent the electronic device from using the audio connector to transmit or receive audio data through the 3.5 mm audio connector. The use of multiple male portions creates additional support for the electronic device's connection to the Cord and reduces the risk that a single male portion would be damaged by a device through prolonged use or weight exceeding the yield strength of the working male connector. As noted above, the connection between the male plug of the Cord and the electronic device is limited to the connection between the plug and the internal receptacle(s) of the electronic device. The Cord does not engage the device other than with the protrusion surface and male portion(s).

The cord mounts described above offer many advantages on a laptop, the smartphone can be positioned to the right or left of the keyboard as shown in FIG. 2. In a car, a user can attach the Cord to any standard 5V USB car charger and enjoy increased accessibility to the electronic device's directions, GPS navigation, or hands-free calling as illustrated in FIG. 3. On a desktop or table, either with or without an available female USB-A port, a user can prop up the electronic device by bending the Cord into a shape that keeps the electronic device screen angled upwardly for the user's viewing as shown in FIGS. 27-30, or as otherwise desired.

Additional advantages of these embodiments include the fact that fewer cords and electronic devices clutter the working surface of a user's desk since each electronic device and Cord are supported above the desk for easy viewing. Secondly, the electronic device can act as a secondary display for the user, showing, for example, real time data on social networks, music, weather, or as a terminal for video calls. Thirdly, the electronic device can be charged while plugged in, keeping it in a ready state of use. Fourthly, constant connection to a computer allows more convenient access to the electronic device for the purposes of syncing data and transferring files.

1. A repositionable support for an electronic device of the type having at least one standardized plug receptacle for receiving a plug of standardized dimensions, said support comprising:
an elongated, bendable body portion which is selectively bendable into a plurality of different configurations for selectively supporting an electronic device in one of a plurality of different positions, said body portion comprising a first end and a second end;
a first plug configured for insertion into a plug receptacle having standardized dimensions and designed for receiving a plug of standardized dimensions, wherein said first plug is disposed at said first end of said body portion, said first plug comprising a body portion comprising a protrusion surface and a conductive portion extending from said protrusion surface;
a second plug configured for insertion into a plug receptacle having standardized dimensions and designed for receiving a plug of standardized dimensions, wherein said second plug is disposed at said second end of said body portion, said second plug comprising a body portion comprising a protrusion surface and a conductive portion extending from said protrusion surface;
said body portion comprising at least one electrical conductor connecting said first plug and said second plug;
said body portion having sufficient yield strength to support the weight of an electronic device attached to said first plug in any one of said plurality of different configurations; and
wherein the support does not have any other structure for supporting an attached electronic device, such that an electronic device supported by said repositionable support is contacted only by said conductive portion and said protrusion surface of one of said plugs.

2. A repositionable support according to claim 1 wherein said body portion comprises a coiled metal gooseneck body.

3. A repositionable support according to claim 2 wherein said body portion further comprises a metal wire which increases the effective yield strength.

4. A repositionable support according to claim 1 wherein said body portion further comprises a metal wire which increases the effective yield strength.

5. A repositionable support according to claim 2 wherein said at least one electrical conductor comprises a plurality of conductors for power and data communication.

6. A repositionable support according to claim 1 wherein said at least one electrical conductor comprises a plurality of conductors for power and data communication.

7. A repositionable support according to claim 1 wherein said body portion comprises a resilient support.

8. A repositionable support according to claim 7 wherein said resilient support comprises a metal wire.

9. A repositionable support according to claim 7 further comprising a sheath over said resilient support.

10. A repositionable support according to claim 1 wherein said body portion comprises polycaprolactone.

11. A repositionable support according to claim 1 wherein said body portion comprises hollow ball pivot links.

12. A repositionable support according to claim 1 wherein at least one of said plugs is a USB plug.

13. A repositionable support for an electronic device according to claim 1 wherein said first plug comprises a conductive portion with an external width which is larger than the maximum standardized external width of the corresponding portion of plugs of standardized dimensions for the intended plug receptacle.

14. A repositionable support for an electronic device according to claim 13 wherein said first plug comprises a conductive portion with an external height which is larger than the maximum standardized height of the corresponding portion of plugs of standardized dimensions for the intended plug receptacle.

15. A repositionable support for an electronic device according to claim 1 wherein said first plug comprises a conductive portion with an external height which is larger than the maximum standardized height of the corresponding portion of plugs of standardized dimensions for the intended plug receptacle.

16. A repositionable support for an electronic device of the type having at least one standardized data/power plug receptacle for receiving a plug of standardized dimensions, said support comprising:
an elongated, bendable body portion which is selectively bendable into a plurality of different configurations for selectively supporting an electronic device in one of a plurality of different elevated positions, said body portion comprising a first end and a second end;
a first male plug configured for insertion into an electrical receptacle of an electronic device having standardized dimensions and designed for receiving a plug of standardized dimensions, said first plug comprising a first portion having at least one dimension which is larger than a corresponding dimension of a corresponding portion of plugs of standardized dimensions for the intended plug receptacle, wherein said first plug is disposed at one end of said body portion,
said body portion has sufficient yield strength to support the weight of an electronic device attached to said first plug in any one of said plurality of different configurations, and
said support does not have any structure which contacts the device other than said male plug.

17. A repositionable support for an electronic device according to claim 16 further comprising a second plug disposed at said second end of said body portion.

18. A repositionable support according to claim 17 further comprising at least one electrical conductor comprising a plurality of conductors for power and data communication, said conductor electrically connecting said first plug and said second plug.

19. A repositionable support according to claim 16 wherein said body portion comprises a coiled metal gooseneck body.

20. A repositionable support for an electronic device according to claim 16 wherein said first plug comprises a conductive portion with an external width which is larger than the maximum standardized external width of the corresponding portion of plugs of standardized dimensions for the intended plug receptacle.

21. A repositionable support for an electronic device according to claim 20 wherein said first plug comprises a conductive portion with an external height which is larger than the maximum standardized height of the corresponding portion of plugs of standardized dimensions for the intended plug receptacle.

22. A repositionable support for an electronic device according to claim 16 wherein said first plug comprises a conductive portion with an external height which is larger than the maximum standardized height of the corresponding portion of plugs of standardized dimensions for the intended plug receptacle.

23. A repositionable support for an electronic device of the type having at least one standardized plug receptacle for receiving a plug of standardized dimensions, said support comprising:
an elongated, bendable body portion which is selectively bendable into a plurality of different configurations for selectively supporting an electronic device in one of a plurality of different positions, said body portion comprising a first end and a second end;
a first plug configured for insertion into a plug receptacle having standardized dimensions and designed for receiving a plug of standardized dimensions, wherein said first plug is disposed at said first end of said body portion, said first plug comprising a body portion comprising a protrusion surface and at least one male portion extending from said protrusion surface;
a second plug configured for insertion into a plug receptacle having standardized dimensions and designed for receiving a plug of standardized dimensions, wherein said second plug is disposed at said second end of said body portion, said second plug comprising a body portion comprising a protrusion surface and at least one male portion extending from said protrusion surface;
said body portion comprising at least one electrical conductor connecting said first plug and said second plug;
said body portion comprising a coiled metal gooseneck conduit and a metal wire disposed in said conduit, said body portion having sufficient yield strength to support the weight of an electronic device attached to said first plug in any one of said plurality of different configurations; and
wherein the support does not have any other structure extending past the protrusion surface which supports the exterior surfaces of an attached electronic device, such that an electronic device supported by said repositionable support is contacted only by said at least one male portion and said protrusion surface of one of said plugs.

24. A repositionable support for an electronic device according to claim 23 wherein said first plug includes a second male connector extending from said protrusion surface having standardized dimensions and configured for insertion into a plug receptacle having standardized dimensions.

25. A repositionable support for an electronic device according to claim 24 wherein said second male conductor is a non-conductive plug.

26. A repositionable support for an electronic device according to claim 25 wherein said second male connector is in the shape of a 3.5 mm audio connector.
